(19) United States
(12) Patent Application Publication
(10) Pub. No.: US 2007/0029139 A1
(43) Pub. Date: Feb. 8, 2007

(54) Oil changing system and method

(75) Inventors: Harold E. Erwin, Augusta, KS (US); Michael J. Erwin, Augusta, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: BG Products, Inc., Wichita, KS (US)

(21) Appl. No.: 11/197,935

(22) Filed: Aug. 5, 2005

(51) Int. Cl. F16N 33/00

(52) U.S. Cl. 184/1.5

(57) ABSTRACT

The present invention is directed to a device and method for removing and replacing oil in an engine in a vehicle. The device includes a container and a control system. The container contains a cap assembly, a tubular housing, and a base assembly. The tubular housing is located between the cap and base assemblies and is sealably coupled therewith. The control system includes a pressure system and a transport system. The pressure system includes a pressure gauge, a vent valve, an air valve, and a regulator. The pressure system is connected to an air source. The transport system includes a control valve, an air hose adaptor, and an oil port connector. The transport system is connected to the pressure system via a connector hose. In operation the device operates to remove and replace the oil in a engine prior to startup.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

The invention relates generally to the field of maintaining vehicles. More specifically, the present invention relates to cleaning the oil system of vehicles. Even more specifically, the present invention relates to a system and method for removing the oil from an engine. Even more specifically, the present invention relates to a system and method for pre-lubricating the engine prior to startup.

Typically, internal combustion engines use a lubricant medium, usually oil, to lubricate their internal moving components. Four-stroke cycle and some two-stroke cycle engines also contain a sump from which the lubricating oil is drawn and pumped through the parts to be lubricated. Further, most multiple cylinder engines are equipped with an oil filter to help prolong the life of the lubricant by capturing any suspended debris before it reaches areas with critical tolerances. After continuous use, the oil becomes contaminated from combustion by-products, fuel and wear metals. Thus, the oil must then be removed and replaced with fresh oil.

A problem occurs due to the design of most engines in that the draining of the engine does not completely remove all of the contaminated oil contained therein. In most cases involving multiple cylinder engines with built in oil sumps, 10-20% of the contaminated is not removed during the normal oil change process. Some of the contaminated oil remains trapped in vital engine parts such as the bearings, the crankshaft, the hydraulic lifters, and the push rod areas. The amount of used oil left in the engine contaminates the new oil that is added as part of an oil change thereby requiring more frequent oil changes and decreased engine life.

A number of prior art systems and methods have been devised in an attempt to correct this problem. However, most of the known systems and methods are very expensive and cannot be justified if they are only used in conjunction with every normal oil change. Further, the systems are very large and cumbersome. Still further, most are mounted on wheels and take up valuable shop space. They also require time to set up and consume large quantities of flushing chemicals and filters. Still further, they are only used in shop oil change areas when their specific engine cleaning service is sold, in addition to a regular oil change. Further, they require special adaptors designed to replace the vehicles oil filter and the oil pan drain plug. The bulk of the patents issued involve these special adaptors and their usage. One example of such an adaptor is disclosed in U.S. Pat. No. 4,278,275 to Deiderich. Deiderich discloses a universal coupling adapter for attachment to the fluid reservoir of an engine, transmission unit, or other hydraulic system in place of a standard spin-on fluid filter. The adaptor contains inlet and outlet ports that allow fluid from the reservoir to be conveyed to a remotely-located fluid circulation device, such as a fluid filter, cooler, or both, and then returned to the reservoir.

Additionally, these known prior art systems create another significant problem once all of the oil is removed. The problem occurs because the engine is void of any lubricant in the critical internal areas such as the rod and main bearings. During startup, the vehicles oil pump will require a few seconds to prime and pump oil from the sump into these critical areas. As such, starting the engine at this time without proper lubrication in these areas can cause significant damage in a short amount of time. The same problem can occur in “dry” start up with a new or rebuilt engine that has just been assembled. In the short time between start up and when the lubricating oil first reaches critical parts severe damage can take place.

While no current methods exists for relubricating an engine that has been flushed prior to start up, several current methods exist that attempt to alleviate the problem of dry start up on newly assembled engines. One method is to manually pour oil onto the rod and main bearing areas before the oil pan or sump is installed. Oil may also be poured or sprayed into the combustion chamber to wet the cylinder walls. However, this method is extremely messy and inexact as oil drips everywhere and often does not reach the critical areas due to external tolerances of the engine parts.

Another method of pre-lubricating is to access the newly assembled engine via the spark distributor port. A drill motor with a slotted long shaft is used to go through the distributor port to turn the oil pump without turning the other components of the engines. However, this method may not be done on many modern distributor less engines.

Therefore, a need exists in the art for a system and method which is simpler to use, more compact, less complex in terms of its components, used in combination with a conventional oil change and capable of adequately removing the trapped oil from the engine and providing pre-lubrication prior to start up.

### SUMMARY OF THE INVENTION

The present invention solves these problems existent in the prior art devices by providing a device for removing and replacing oil in an engine in a vehicle that uses a container and a control system. The container contains a cap assembly, a tubular housing, and a base assembly. The tubular housing is located between the cap and base assemblies and is sealably coupled therewith. A plurality of support rods are used to interconnect the cap and base assemblies. The support rods extend along length of the housing between the cap and base assemblies and are threadably received therein.

The control system includes a pressure system and a transport system. The pressure system includes a pressure gauge, a vent valve, an air valve, and a regulator. The pressure gauge, vent valve, and regulator are each sealably coupled to the cap assembly and are in fluid communication with the tubular housing. The pressure gauge measures the pressure within the apparatus. The vent valve is adapted to release pressurized air from the container. The regulator enables the user to control the rate of air flow into the container. The air valve is coupled to the regulator and is a shut-off switch that controls entry of air into the regulator.

The transport system includes a control valve, an air hose adaptor, and an oil port connector. The transport system is connected to the pressure system via a connector hose. Specifically, the regulator of the pressure system is connected to the control valve of the transport system via the connector hose. The control valve is a T-shaped connector with multiple connectors and a lever. The control valve is connected to the base assembly and is in fluid communication with the tubular housing. The air hose adaptor is connected to the control valve at a first end and to the oil port connector at a second end. The lever on the control valve is movable between an “OIL” position and an “AIR” position thereby controlling whether oil or air is introduced into the engine via the transport system of the apparatus.

A suspension hook is also provided that enables the container to be conveniently hung from the underside of the hood of a vehicle or in some other location.

### BRIEF DESCRIPTION OF THE SEVERAL VIEWS OF THE DRAWINGS

The present invention is described in detail below with reference to the attached drawing figures, wherein:

FIG. 1 is a perspective view of the oil removal and replacement system of the present invention in use removing and replacing the oil in a vehicle engine;

FIG. 2 is a front plan view of the oil removal and replacement system of FIG. 1;

FIG. 3 is partial, enlarged view of the oil port connector and the oil port, wherein the oil port connector is an oil purge probe; and

FIG. 4 is a partial, enlarged view of the oil port connector and the oil port where the oil port connector is an oil port adaptor.

### DETAILED DESCRIPTION OF THE INVENTION

The present invention is designed to connect to a vehicle in a way that it taps into the vehicles oil filter housing. By connecting a relatively small container to the oil filter port and to a shop air hose, the container functions without the assistance of any other supporting equipment. It simply feeds into the engine using pressurized air.

The container is adapted to hold a lubricating medium such as oil. The container is also adapted to provide pressurized air flow. The device of the present invention is very simple, and is easy to use, unlike the prior art devices. It uses a clear fiberglass housing for its container.

This present invention is designed to remove oil from two and four stroke cycle engines that have an internal oil sump. Further, the invention is designed provide an accessible method of entering the engine through an oil filter port. Still further, this invention is primarily designed to remove oil from engines that have an oil pump to circulate the lubricating oil through the moving parts. This invention is designed to perform equally well with both compression ignition (diesel, natural gas, or alcohol) or spark ignition engines. Even further, this invention is designed to perform with passenger cars of all sizes, stationary engines, marine engines, light trucks to medium duty trucks and similar engines. The present invention, of course, is not intended to be limited to such applications.

This present invention is highly versatile and can be used in any location where vehicles receive engine oil changes and where shop air is available. It can also be used in plants and shops that build or rebuild engines and shops that install new and rebuilt engines. The apparatus is very small and can hang on a peg board or small roll around IV stand.

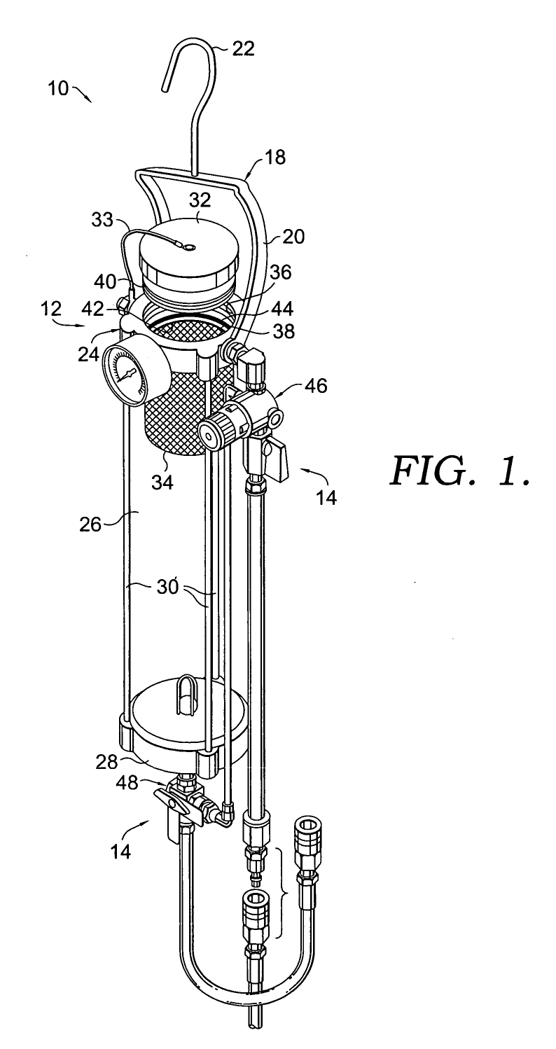

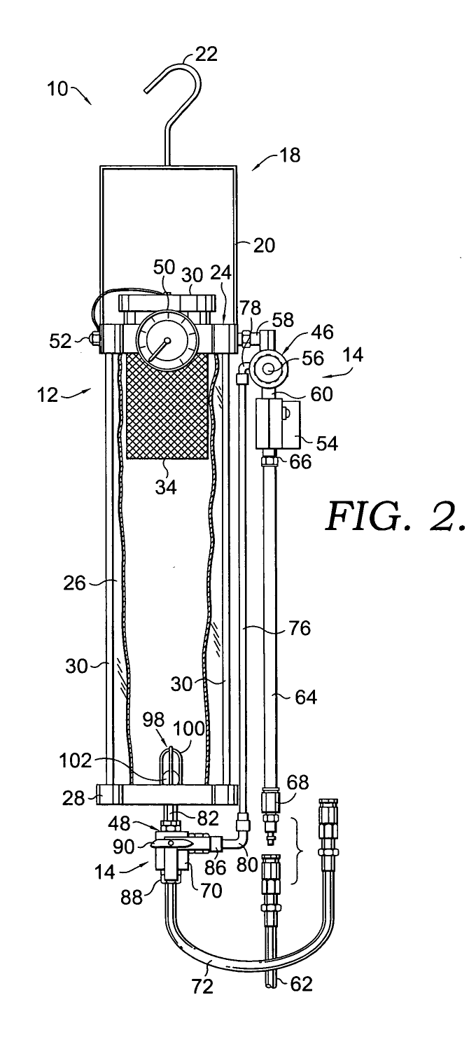

With initial reference to FIGS. 1 and 2, an oil removal and replacement apparatus according to the principles of the present invention is designated generally with the reference numeral 10. Referring now to FIG. 1, the apparatus 10 includes a container 12 and a control system 14. The container 12 may be mounted on a peg board or IV stand, not shown, via a mounting system 18. The mounting system 18 is attached to an upper portion of the container 12 and includes a bracket 20 and a hanger 22. Any attachment method may be used. The hanger 22 is coupled to the bracket 20 at an intermediate position and depends upwardly therefrom.

Referring again to FIG. 1, the container 12 will be discussed. The container includes a cap assembly 24, a tubular housing 26, and a base assembly 28. It should be understood that when assembled, the cap assembly 24, tubular housing 26, and base assembly 28, provide a unit suitable for pressurized flow. The cap assembly is located at an upper portion of the container 12 while the base assembly 28 is located at a lower portion. The tubular housing 26 extends between the cap assembly 24 and the base assembly 28. The tubular housing 26 is hollow thereby providing a reservoir for the oil during operation. A plurality of support rods 30 extend along the length of the tubular housing 26 and between the cap assembly 24 and the base assembly 28. The rods 30 are located outside of the tubular housing 26 and are attached to the cap and base assemblies 24, 28. The rods 30 contain upper and lower threaded portions, not shown, that mate with a plurality of internally threaded apertures, not shown, located in the cap and base assemblies 24, 28. The cap and base assemblies 24, 28 are constructed from aluminum while the tubular housing 26 is constructed from a transparent fiberglass material. It should be noted that any suitable material may be used for each component and still fall within the scope of the present invention.

Referring now to FIG. 1, the cap assembly 24 will be discussed. The cap assembly 24 includes a fill cap 32 and a filter screen 34. The cap assembly 24 is generally cylindrical in nature and has a threaded hole 36 and an enlarged aperture 38. The fill cap 32 is cylindrical in nature and contains external threads 40. The threaded hole 36 of the cap assembly 24 is sized and adapted to receive the external threads 40 of the fill cap 32. The fill cap 32 is removable such that oil may be added to the container 12 as will be further discussed below. The filter screen 34 is shaped as shown and is sized and adapted to be received in the enlarged aperture 38. Once removed, the fill cap 32 remains connected to the cap assembly 24 via the retention device 33. The filter screen 34 depends downwardly from the cap assembly 24. The filter screen 34 includes a lip 42, which serves to maintain the filter screen 34 in contact with the enlarged aperture 38 of the cap assembly 24.

When screwed into the cap assembly 24 the fill cap 32 forms a sealed relationship with the container using an O-ring 44. The O-ring 44 is constructed of rubber, as is normally the case. When fill cap 32 is screwed into the threaded hole 36 of the cap assembly 24, the O-ring 44 is trapped and forms a compressed seal. This sealed relationship allows the container 12 to be pressurized during operation. The threaded hole 36, as discussed above, serves as a filling hole when the fill cap 32 has been removed.

Referring now to FIG. 2, the control system 14 will be discussed. The control system 14 generally includes a pressure system 46 and a transport system 48. The pressure system 46 includes an air pressure gauge 50, a vent valve 52, an air valve 54, and a regulator 56. The pressure gauge 50 is known in the art and coupled to the cap assembly 24. The pressure gauge 50 measures the pressure within the container 12. The vent valve 52 and regulator 56 extend from the cap assembly 24 and are located in opposed relation to one another. The vent valve 52 is a standard item that is known in the art and is threadably received within an aperture, not shown, in the cap assembly 24. The aperture passes through the cap assembly 24 to provide fluid communication between the container 12 and the atmosphere. The vent valve 52 is adapted to release pressurized air from the container 12.

The regulator 56 is a standard item that is known in the art and coupled to the cap assembly 24 via a first connector 58. The regulator 56 is located opposite the vent valve 52. It should be understood by one of ordinary skill in the art that any attachment method may be used. The regulator 56 enables the user to control the amount of air allowed into the container 12 and the transport system 48. As stated above the regulator 56 is coupled to an aperture, not shown, located in the cap assembly 24 via the first connector 58. The aperture passes through the cap assembly 24 to provide fluid communication between the regulator 56 and the tubular housing 26. The regulator 56 is coupled to the air valve 54 via a second connector 60. The air valve 54 is a shut-off type that enables the user to administer or not administer air into the regulator 56 and thus the container. The air valve 54 has two positions, “ON” and “OFF.” It should be obvious that in the “ON” position air is allowed to flow to the regulator 56, while in the “OFF” position it is not. The air source may be a standard shop air hose 62, or come from any other suitable source. One skilled in the art will be well aware of potential sources which might be used, and the invention is not intended to be limited to any particular source of air. Almost all automotive service centers will have shop air available which will suffice for these purposes. The shop air hose 62 is connected to the air valve 54 via an intermediate hose 64 and a pair of connectors 66, 68 located at upper and lower ends of the hose 64. Each of the hoses and connectors mentioned above are standard items known by one of ordinary skill in the art.

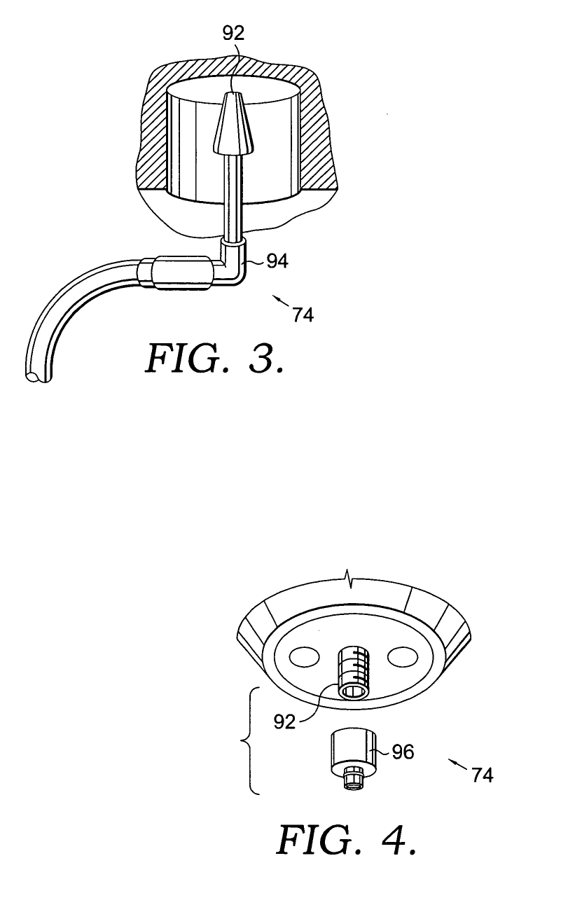

Referring again to FIG. 2, the transport system 48 will be discussed. The transport system 48 consists of a control valve 70, a connector hose 72, and an oil port connector 74, shown in FIGS. 3 and 4. The transport system 48 is connected to the pressure system 46 via a connector hose 76 and a pair of L-shaped connectors 78, 80. Specifically, the connector hose 76 is coupled to the regulator 56 at an upper end with L-shaped connector 78, and the control valve 70 at a lower end with L-shaped connector 80. It should be appreciated by one of ordinary skill in the art that any suitable connection means may be used. The control valve 70 is a T-shaped connector with multiple connectors. The first connector 82 of the control valve 70 is threadably received in an aperture 84, not shown, located in the base assembly 28. The aperture 84 passes through the base assembly 28 to provide fluid communication between the control valve 70 and the tubular housing 26. The second connector 86 of the control valve 70 is coupled to the connector hose 76 via the L-shaped connector 80 as discussed above. The third connector 88 of the control valve 70 is coupled to the connector hose 72. The control valve 70 further contains a lever 90 that is movable between an “OIL” position and an “AIR” position. Specifically, the lever 90 is generally vertical in the “OIL” position and generally horizontal in the “AIR” position. As such, when the lever 90 is place in the “OIL” position, oil is allowed to pass from within the tubular housing 26 to the connector hose 72. Additionally, when the lever 90 is placed in the “AIR” position, air is allowed to pass from the shop air hose through the pressure system 46 and out the connector hose 72.

As stated above the connector hose 72 is coupled to the third connector 88 of the control valve 70 at one end and to the oil port connector 74 at the other end. The air hose adaptor is a standard item that is known to one of ordinary skill in the art. The universal nature of the air hose adaptor 72 allows for easy connectability to multiple types of oil port connectors 74. Thus, as seen in FIGS. 3 and 4, the oil port connector 74 may come in many forms depending on the connection type at the oil port 92. For example, if a filter is a drop-in cartridge type an oil purge probe 94 will be used as the oil port connector 92. However, if a standard filter is used an oil port adaptor 96 will be used as the oil port connector 74. While these two specific examples are described they are not meant to be limiting.

The transport system 48 further contains a float valve 98. The float valve 98 is a standard item that is known to one of ordinary skill in the art. The float valve 98 includes a holding apparatus 100 and a ball 102. The float valve 98 is coupled to the aperture 84 in the base assembly 28. The float valve 98 allows the flow of oil from the container 12. The oil is drawn out through the aperture 84 when the lever 90 on the control valve 70 is turned to the “OIL” position and the air valve 54 is turned to the “ON” position as will be discussed further below.

The operation of the oil changing system will now be discussed. The following discussion relates to an engine having an oil filer connected to an oil filter port and a drain plug connected to a oil pan drain. However, the discussion below is not meant to be strictly limited to such a configuration. Before removing the contaminated oil from the engine, the container should be prepared by securely replacing the fill cap 32 and closing the vent valve 52. This seals the apparatus 12 for pressurizing. Next, the user should turn the air valve 54 on the air line going to the apparatus to the closed “OFF” position. After that, the user connects the shop air hose 62 to the connector 68 on the intermediate hose 64.

To remove the dirty oil, the drain plug is removed from the oil pan drain on the engine and the oil is allowed to drain therefrom. The oil should then be allowed to drain until it stops flowing. The drain plug should not be replaced at this time. The oil filter should then be removed from the engine. Next the oil port adaptor 74 is attached to the oil filter port 92. As seen in FIG. 3, if the filter is a drop-in cartridge type an oil purge probe 94 will be used as the oil port connector 92. However, as seen in FIG. 4, if a standard filter is used an oil port adaptor 96 will be used as the oil port connector 74. Regardless, the connector hose 72 from the apparatus 10 is then connected to the oil port connector 74 and the lever 90 on the control valve 70 is turned to the “AIR” position. Next the air valve 54 on the pressure system 46 is turned to the “ON” position and air is forced through the engine galleys and causes oil to flow from the oil pan drain. When the used oil stops flowing, the air valve 54 on the pressure system 46 should be turned to the “OFF” position and the drain plug is replaced in the oil pan drain. All the contaminated oil in the engine will now have been removed.

To replace the oil for initial lubrication the user first removes the fill cap 32 of the apparatus 10 and pours in an appropriate amount of the engine oil. An appropriate amount will usually be one liter or one quart for smaller vehicles and up to two quarts for larger capacity diesels engines. If oil additives or enhancers are to be installed, they should be added to the oil in the apparatus at this time.

Next the user turns the control valve 70 on the apparatus 10 to the “OIL” position and slowly opens the air valve 54 on the pressure system 46. It should be noted that the connector hose 72 from the apparatus 10 is still connected to the oil port connector 74. At this time the oil in the cylinder will begin to flow into the engine and through the areas where the used trapped oil had been. The oil should be allowed to flow until the canister is empty and the float valve 98 has closed shutting off oil flow. Once the canister is empty the air valve 54 on the apparatus 10 should be turned to the “OFF” position. The vent valve 52 should then be pressed to release all air pressure from the apparatus 10. The oil port connector 74 should then be removed and the new oil filter installed. The drain plug will then be replaced and the engine will be filled with the requisite amount of oil required to bring it to its normal capacity with filter change.

The present invention has been described in relation to particular embodiments, which are intended in all respects to be illustrative rather than restrictive. Alternative embodiments will become apparent to those skilled in the art to which the present invention pertains without departing from its scope.

It will be seen from the foregoing that this invention is one well adapted to attain the ends and objects set forth above, and to attain other advantages, which are obvious and inherent in the device. It will be understood that certain features and subcombinations are of utility and may be employed without reference to other features and subcombinations. This is contemplated. It will be appreciated by persons skilled in the art that the present invention is not limited to what has been particularly shown and described hereinabove. Rather, all matter herein set forth or shown in the accompanying drawings is to be interpreted as illustrative and not limiting.

The invention claimed is:

1. A device for removing and replacing a fluid in an engine having an oil port, said device using an air source and a flowing fluid, said device comprising:
a container having a fill cap for receiving the flowing fluid;
a valve assembly coupled to the container for receiving air from the air source;
a control valve coupled to the container, the control valve being adapted to move between a first position and a second position;
a first connector coupling the valve assembly to the control valve; and
a second connector coupled to the control valve, wherein the second connector is adapted to be connected to the oil port of the engine;
wherein when in the first position, air is introduced into the engine by the connector and wherein when in the second position, flowing fluid is introduced into the engine by the connector.

2. The device of claim 1, wherein the valve assembly is in fluid communication with the container.

3. The device of claim 2, wherein the valve assembly includes a regulator; the regulator being adapted to regulate the amount of air allowed into the container.

4. The device of claim 3, wherein the valve assembly further includes an air valve, the air valve being adapted to move between a first position and a second position wherein the first position air is allowed to flow from the air source into the contain and wherein the second position air is not permitted to flow from the air source.

5. The device of claim 4, wherein the control valve is in fluid communication with the container.

6. The device of claim 5, wherein the container includes a cap assembly, a cylindrical housing coupled to an upper portion of the housing, and a base assembly coupled to a lower portion of the housing, the container being pressurized for fluid flow therefrom, wherein the valve assembly is coupled to the cap assembly and the control valve is coupled to the base assembly.

7. The device of claim 6, wherein the cap assembly has a vent valve coupled thereto, the vent valve being in fluid communication with the container.

8. The device of claim 7, wherein the cap assembly has an air pressure gauge coupled thereto.

9. The device of claim 8, wherein the cap assembly further includes a filter.

10. The device of claim 9, wherein the cylindrical housing is transparent.

11. The device of claim 1, further comprising a suspension hook attached atop said container for hanging said container.

12. A method for removing and replacing contaminated fluid in an engine having an oil filter with an oil port and a drain plug, the method comprising:
removing the drain plug from the engine;
draining said contaminated fluid from the engine;
removing the oil filter to expose the oil port;
providing a container which is adapted to accept an amount of replacement fluid;
delivering pressurized air from an air source to said oil port to pneumatically remove remaining contaminated fluid from said engine; and
administering pressurized air to compel at least some of said replacement fluid from said container and forcibly deliver said at least some replacement fluid into said engine to replace said remaining contaminated fluid.

13. The method of claim 12, comprising:
including an air-tight cap on said container; and
performing said providing step by removing said cap, filling said chamber with replacement fluid, and then replacing said air-tight cap.

14. The method of claim 13, comprising:
providing a conduit from said container to said oil port;
providing a valving arrangement, said arrangement initially configured to accomplish said delivering step through a conduit to said oil port; and
switching said valving arrangement such that said pressurized air from said air source is redirected to be introduced into the top of said container compelling replacement fluid through said conduit to accomplish said administering step.

15. The method of claim 14, comprising:
presenting a first valve which accepts pressurized air from said source and then directs said air optionally to said upper portion of said container or to said conduit; and
interposing a second valve in said conduit, said second valve adapted to allow one of: (i) pressurized air from said first valve into said conduit; and (ii) replacement fluid from said container into said conduit.

16. The method of claim 15, comprising:
providing a filter for filtering said replacement fluid.

17. The method of claim 16, comprising:
constructing said container of a transparent material.

18. An engine-fluid changing system comprising:
a container having a reservoir for replacement fluid; and
an air-delivery subsystem adapted to operate in a first mode of operation and a second mode of operation such that when in said first mode, pressurized air is delivered to an oil port on an already-drained engine to blow out contaminated oil remaining is said engine and such that when in said second mode, pressurized air forces at least a portion of said replacement fluid into said engine through said oil port.

19. The engine-fluid changing system of claim 18, wherein said first and second modes of operation are accomplished using a valving arrangement.
